(19) United States
(12) Patent Application Publication
(10) Pub. No.: US 2025/0143320 A1
(43) Pub. Date: May 8, 2025

(54) METHOD FOR ENHANCING THE YIELD OF GRAIN CROPS

(71) Applicants: Dmitriy Semenovich STREBKOV, Moscow (RU); Mikhail Ivanovich BUDNIK, Krasnogorsk (RU); Valeriy Vladimirovich TURBIN, Moscow (RU); Mikhail Valentinovich ROZANTSEV, Moscow (RU)

(72) Inventors: Dmitriy Semenovich STREBKOV, Moscow (RU); Mikhail Ivanovich BUDNIK, Krasnogorsk (RU); Valeriy Vladimirovich TURBIN, Moscow (RU); Mikhail Valentinovich ROZANTSEV, Moscow (RU); Vladimir Yurievich DUSHKOV, s. Nemchinovka (RU); Lyudmila Magomedovna APASHEVA, Moscow (RU); Anton Valerievich LOBANOV, Moscow (RU); Elena Nikolaevna OVCHARENKO, Moscow (RU)

(21) Appl. No.: 18/720,650

(22) PCT Filed: Dec. 8, 2021
(86) PCT No.: PCT/RU2021/000556

§ 371 Date: Jun. 16, 2024

(51) Int. Cl. A01N 59/00; A01N 25/02; A01P 21/00

(52) U.S. Cl. CPC A01N 59/00; A01N 25/02; A01P 21/00

(57) ABSTRACT

The invention relates to the field of agriculture, and more particularly to the cultivation of grain crops, in particular winter wheat. Seeds are sprayed with an environmentally-safe aqueous solution of hydrogen peroxide in a concentration range of from 2.94 μmol/L, or 0.1 mg/L, to 82.0 μmol/L, or 2.79 mg/L, and then left to stand for from 10 to 15 hours before being sown, and the plants are likewise sprayed in the late period of growth with an environmentally-safe aqueous solution of hydrogen peroxide in a concentration range of from 2.94 μmol/L, or 0.1 mg/L, to 82.0 μmol/L, or 2.79 mg/L. The result is earlier germination of the seeds and a significant increase in the yield of grain crops.

The invention relates to the field of agriculture and may be used in the cultivation of grain crops, in particular, winter crops of wheat at the stage of seed preparation for sowing and in the late vegetation period of the plants.

The method of presowing treatment of seeds of grain crops using electrochemically activated water is known (RU No. 2263432, IPC A01C 1/00).

A technical disadvantage of this method is lack of final result—the experiments were limited to germination of seeds and determination of seed germination energy in the amount of 50 to 100 seeds, which is not a rationale for the yield prediction and determination. Tap water, which cannot be standardized for physicochemical properties in different regions of the country, was subjected to electrochemical activation, and chlorination of tap water is the most common method of water disinfection, which is also undesirable in crop production. Moreover, the electrochemically activated water was obtained at the STEL-MT-1 unit, which was designed according to the regulations only for obtaining electroactivated solutions of cooking salt.

The closest and accepted as a prototype is the method of cultivation of winter wheat, which includes seed soaking in anolyte or catholyte, obtained as a result of electrochemical activation of water, for 8-10 hours, after which the seeds are embedded in the soil without drying. (RU No. 2246813, IPC A01C 1/00).

The disadvantage of the method prototype is the fact that it is practically difficult to soak a large mass of seeds directly in the field, wet grains will stick together in the seeding unit, clog the ejection holes, which will lead to uneven seeding intervals, require additional tedding of seeds in the hopper of the seeding unit, which ultimately violates the seeding technology and leads to a low yield increase compared to the control, namely: 117.3% for anolyte and 120.4% for catholyte. The experiments were conducted on the fields of the Lower Volga region with Don-95 winter wheat variety.

The object of this invention is to provide a method for increasing the yield of grain crops.

To attain the objective set it is proposed to use pre-sowing spraying of seeds and spraying of plants in the late vegetation period with ecologically pure aqueous solution of hydrogen peroxide in natural concentration

The technical result consists in the grain crop yield increase.

The technical result is achieved by the fact that in the method of increasing the yield of grain crops, the seeds undergo presowing spraying with an environmentally friendly aqueous solution of hydrogen peroxide in the concentration range from 2.94 μmol/L, or 0.1 mg/L, to 82.0 μmol/l, or 2.8 mg/1, after which the seeds are kept from 10 to 15 hours and then sowing is carried out, and in the late vegetation period of grain crops they are also sprayed with environmentally friendly aqueous solution of hydrogen peroxide in the same concentration range.

In an embodiment of the method, the seeds undergo only presowing spraying with an environmentally friendly aqueous solution of hydrogen peroxide at a concentration range from 2.94 μmol/L, or 0.1 mg/L, to 82.0 μmol/L, or 2.8 mg/L, after which the seeds are kept for 10 to 15 hours and the sowing is performed.

In another embodiment of the method, only spraying in the late growing season of grain crops with an environmentally friendly aqueous solution of hydrogen peroxide at a concentration range from 2.94 μmol/L, or 0.1 mg/L, to 82.0 μmol/L, or 2.8 mg/L, is performed.

The method of increasing grain crops yield by presowing spraying of seeds and spraying of plants in the late vegetation period with environmentally friendly aqueous solution of hydrogen peroxide in natural concentration shall be implemented as follows.

It is known that hydrogen peroxide (hydrogen peroxide, H₂O₂) plays an essential role in the Earth's biosphere, in particular, in the vital activity of plants ( [symbol] : [symbol] [symbol] (Photosynthesis: a physico-chemical approach)—Moscow: Editorial URSS 2003, Section 3.3 “Hydrogen peroxide is a source of photosynthetic oxygen (hydrogen),” pp. 154-170).

For the first time the formation of hydrogen peroxide under high-energy action in the atmosphere was discovered by Meissner back in the XIX century, namely: he discovered the presence of hydrogen peroxide in thunderstorm rain. In the same XIX century, Schöne found that near Moscow, the concentration of hydrogen peroxide “in thunderstorm rain is equal to 1 mg/l” (cit. ex. Pozin. M. E. [symbol] [symbol] , (Hydrogen peroxide and peroxide compounds) State Publishing House of Scientific and Technical Literature: Leningrad, Moscow, 1951, p. 31). In general, near Moscow for the period from 1874 to 1894 it was found that the content of H₂O₂ “in rainwater is 0.4-1 mgr. per 1 liter” (quoted from the Encyclopedic Dictionary of F. A. Brockhaus, I. A. Efron, Article « [symbol] ». (Hydrogen peroxide)—SPb., 1898.—Vol. XXIII.—p. 215).

In comparison, in marine rain in the Gulf of Mexico region, where frequent and more severe tropical thunderstorms occur, hydrogen peroxide concentrations range from 11.4 to 82 μmol/L, or 0.4 to 2.8 mg/L with a mean of 40.2 μmol/L, or 1.4 mg/L (Cooper W. J., Saltzman E. S., Zika R. G. «The contribution of rainwater to variability in surface ocean hydrogen peroxide», Journal of Geophysical Research, 1987. V. 92. P. 2970. DOI: 10.1029/JC092iC03p02970), which is comparable to the concentration of H₂O₂ in the thunderstorm rain near Moscow. In the same area the highest concentration of hydrogen peroxide in rainwater on Earth—82 μmol/L, or 2.8 mg/L—was also recorded.

Estimation of the annual flux of H₂O₂ in water precipitation demonstrated that 2-1011 moles of hydrogen peroxide, i.e., about 107 tons, reach the Earth with the rainfall every year (Domrachev G. A., Selivanovsky D. A., Stunzhas P. A. et al. Efficiency of hydrogen peroxide and water radical formation in nature/IPF RAS Preprint No. 537. Nizhny Novgorod, 2000), which allows us to consider the formation of H₂O₂ in the atmosphere as the main source of hydrogen peroxide on Earth, and it is found everywhere on Earth—in rainwater over the sea and land, in the sea and fresh water with concentrations in the range of tens of μmol/L. This is consistent with the viewpoint of D. I. Mendeleev: «The weaker the solution of hydrogen peroxide in water, the more constant it is” (cit. ex. [symbol] . [symbol] .(Mendeleev D. Fundamentals of Chemistry). SPb: Print house of M. P. Frolova, 7th edition, 1903, p. 152), which is a fundamental condition ensuring the involvement of hydrogen peroxide in biological processes, in particular, in plant life activity.

Thus, the classical equation that captures the basic essence of photosynthesis:

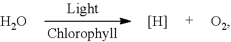

is supplemented by another member, -hydrogen peroxide:

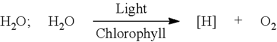

( [symbol] : [symbol] [symbol] (Photosynthesis: a physico-chemical approach)—Moscow: Editorial URSS 2003, Section 3.3 “Hydrogen peroxide is a source of photosynthetic oxygen (hydrogen),” p. 155).

At first glance, it may appear that we are talking about a very small concentration of hydrogen peroxide that has nothing to do with photosynthesis, but this is not true. By evaporating the aqueous solution of peroxide, its concentration can be increased tenfold, since its volatility is much lower than that of water. Thus, the heat of vaporization of pure hydrogen peroxide is 12.33 kcal/mol, water-10.51 kcal/mol. The method of concentrating hydrogen peroxide by simple distillation of water is used in chemical practice.

Transpiration (evaporation of water by plants) performs the same function along with the protection of plants from overheating. Of every kilogram of water absorbed by the roots from the soil, only 1 gram ( 1/1000th part!) is used by the plant to build the tissue. Therefore, a green leaf can be considered as a kind of concentrator capable of increasing the content of hydrogen peroxide in the intracellular fluid by several orders of magnitude compared to its content in the initial water ( [symbol] : [symbol] [symbol] (Photosynthesis: a physico-chemical approach)—Moscow: Editorial URSS 2003, Section 3.3 “Hydrogen peroxide is a source of photosynthetic oxygen (hydrogen),” p. 156).

However, the widespread application of hydrogen peroxide in crop production is hampered by the lack of technology for the production of environmentally friendly hydrogen peroxide in the natural concentration.

Currently, hydrogen peroxide is produced by an electrochemical method through persulfuric acid and organic method of liquid-phase oxidation of isopropyl alcohol according to the standard GOST 177-88 “Hydrogen Peroxide. Specification.” Hereby, the highly-concentrated H₂O₂ solution contains toxic stabilizers (sulfuric acid, arsenic, etc.) added to decelerate decomposition of hydrogen peroxide, and these stabilizers prevent using the solution in crop farming.

To obtain an environmentally friendly aqueous solution of hydrogen peroxide without any chemical stabilizing additives, the authors have created a nature-like method and installation that provides high-energy non-contact impact on water with streamers of high-voltage electric discharge (Strebkov D. S., Budnik M. I., Apasheva L. M. et al. “Obtaining environmentally friendly hydrogen peroxide solutions at high-energy non-contact action on water and their application”//Actual issues of biological physics and chemistry. BFFH-2020: Proceedings of the XV International Scientific Conference, Sevastopol, Sep. 14-16, 2020.—Sevastopol, 2020, pp. 174-175).

For standardization purposes, the initial environmentally friendly hydrogen peroxide solution is obtained from distilled water by exposing it to streamers of high-voltage electric discharge, which is diluted to working concentrations.

The obtained working concentrations of environmentally friendly aqueous solutions of hydrogen peroxide are comparable with the sign of biologically full natural water according to the Interstate Standard GOST 32460-2013 (2.94 μmol/l, or 0.1 mg/l) and with the concentration of hydrogen peroxide in thunderstorm rain of Moscow region (29.4 μmol/l, or 1 mg/l) ( [symbol] [symbol] [symbol] , (Hydrogen peroxide and peroxide compounds) State Publishing House of Scientific and Technical Literature: Leningrad, Moscow, 1951, p. 31), as well as with the average value in rainwater in the Gulf of Mexico region (40.2 μmol/L, or 1.4 mg/L) and do not exceed the highest concentration of hydrogen peroxide in rainwater on Earth-82 μmol/L, or 2.8 mg/L.

The seeds undergo presowing spraying with an environmentally friendly aqueous solution of hydrogen peroxide in the concentration range from 2.94 μmol/L, or 0.1 mg/L, to 82.0 μmol/l, or 2.8 mg/l, after which the seeds are kept from 10 to 15 hours and then sowing is carried out, and in the late vegetation period of grain crops they are also sprayed with environmentally friendly aqueous solution of hydrogen peroxide in the same concentration range.

Only presowing spraying with an environmentally friendly aqueous solution of hydrogen peroxide at a concentration range from 2.94 μmol/L, or 0.1 mg/L, to 82.0 μmol/L, or 2.8 mg/L, after which the seeds are kept for 10 to 15 hours and the sowing is possible.

Only spraying in the late growing season of grain crops with an environmentally friendly aqueous solution of hydrogen peroxide at a concentration range from 2.94 μmol/L, or 0.1 mg/L, to 82.0 μmol/L, or 2.8 mg/L, is possible.

An example of the implementation and effectiveness of the method proposed.

The experiments were conducted on the fields of the Lower Volga region, in particular, on the territory of the Saratov region with Saratovskaya 90 winter wheat variety (grain family) in the period from September 2020 to August 2021.

The initial environmentally friendly hydrogen peroxide solution obtained from distilled water was diluted with local natural water to 5 μmol/L, or 0.17 mg/L, and 50 μmol/L, or 1.7 mg/L, on the basis of using 20 L of working solution of appropriate concentration per ˜1000 kg of winter wheat seed intended for sowing on ˜5 ha.

Four groups of seeds weighing ˜1000 kg each were selected.

The first group was the control group in which the seeds were pre-sprayed with 20 liters of natural local water.

The second group was the farmer's group, where the seeds were pre-sprayed with 20 liters of a complex chemical solution commonly used in winter wheat cultivation.

The third group was the experimental group, in which the seeds were pre-sprayed with 20 liters of ecologically friendly aqueous solution of hydrogen peroxide with the concentration of 5 μmol/L, or 0.17 mg/L (hereinafter referred to as ecoperoxide-5).

The third group was the experimental group, in which the seeds were pre-sprayed with 20 liters of ecologically friendly aqueous solution of hydrogen peroxide with the concentration of 50 μmol/L, or 1.7 mg/L (hereinafter referred to as ecoperoxide-50).

The presowing spraying of seeds was carried out on Sep. 3, 2020. After spraying and thorough mixing, the seeds were poured into bags and kept for 12 hours in the shade. Then on the next day, each group of seeds was sown by an aggregate of seeding machines on ˜5 ha of the field in such a way that the total sowing area amounted to ˜20 ha with a passage width between the groups of 0.7-1 m.

Field germinating capacity: in the third (seed spraying with ecoperoxide-5) and fourth (seed spraying with ecoperoxide-50) experimental groups winter wheat germinated 2-3 days earlier than in the first control and the second farmer groups.

Characteristics of the winter wheat in the stem extension phase are presented in Table 1.

TABLE 1
Characteristics of Saratovskaya 90 winter wheat variety in the stem formation
phase with pre-sowing spraying of seeds with natural local water, farmer's
complex chemical solution, ecoperoxide-5 and ecoperoxide-50 solutions

| | Natural local | Complex | | |
|---|---|---|---|---|
| Indicators | water | chemistry | Ecoperoxide-5 | Ecoperoxide-50 |
| Sheaf height¹, cm | 48.7 ± 1.6 m | 52.0 ± 1.1 | 52.3 ± 1.2 | 53.6 ± 0.9²* |
| Sheaf raw weight¹, g | 23.6 ± 2.7 | 32.1 ± 4.1 | 37.9 ± 2.7²** | 35.0 ± 2.2²** |
| Raw weight of the | 20.3 ± 2.4 | 28.1 ± 3.8 | 33.7 ± 2.5²** | 30.9 ± 1.9²** |
| above-the-ground | | | | |
| part of the sheaf¹, g | | | | |
| Dry weight of the | 9.2 ± 1.0 | 11.0 ± 1.4 | 15.7 ± 2.6²* | 12.8 ± 1.0²* |
| above-the-ground | | | | |
| part of the sheaf¹, g | | | | |

Note:
¹there were 5 plants in a sheaf, statistical analysis was carried out for 7 sheaves;
²differences are reliable in comparison with the characteristics of winter wheat of the first control group “Natural local water” according to Student's t-criterion;
differences are reliable according to Student's t-criterion with the level of significance:
*p < 0.05;
**p < 0.01.

As can be seen from Table 1, the highest values occur in the experimental groups with ecoperoxide-5 and ecoperoxide-50, and, most valuable, the maximum difference between the groups is observed when measuring the dry weight of the above-the-ground part.

In the late vegetation period between the phases of stem extension and milky-wax ripeness of winter wheat, a single spraying of half of each of the four plots, i.e. 2.5 ha in the first, second, third and fourth groups, respectively, was performed. Spraying was carried out with ecoperoxide-solution using a Tuman-3 self-propelled boom sprayer. The second half of the above plots were left unsprayed.

Comparative characteristics of dry weight of the above-the-ground part of winter wheat sheaf in the phase of milky-wax ripeness with spraying with ecoperoxide-5 solution and without spraying in the late vegetation period are presented in Table 2.

TABLE 2
Dry weight of the above-the-ground part of a sheaf of Saratovskaya
90 winter wheat variety in the phase of milky-wax ripeness with
spraying with ecoperoxide-5 and without spraying in the late vegetation
period in groups with different presowing seed spraying

| | Natural local | Complex | | |
|---|---|---|---|---|
| Indicators | water | chemistry | Ecoperoxide-5 | Ecoperoxide-50 |
| Dry weight of the | 12.7 ± 1.3 | 15.6 ± 1.5 | 14.7 ± 1.3 | 19.3 ± 1.8** |
| above-the-ground | | | | |
| part of the sheaf¹ with | | | | |
| spraying, g | | | | |
| Dry weight of the | 12.4 ± 1.7 | 15.3 ± 2.1 | 12.4 ± 1.2 | 16.3 ± 1.7 |
| above-the-ground | | | | |
| part of the sheaf¹ | | | | |
| without spraying, g | | | | |
| Delta in the dry | 0.3 | 0.3 | 2.3 | 3.0 |
| weight of the sheaf | | | | |
| above-the-ground | | | | |
| part, g | | | | |

Note:
¹there were 5 plants in a sheaf, statistical analysis was carried out for 7 sheaves;
**differences are reliable in comparison with the characteristics of winter wheat of the first control group “Natural local water” according to Student's t-criterion with the significance level p < 0.01

As can be seen from Table 2, in all groups, when spraying plants with ecoperoxide-5 solution during the growing season, there was a tendency to higher indices of dry weight of the above-the-ground part of the sheaf compared to the same indices, but without spraying plants during the vegetation period, with a consistent increase in the difference in the dry weight of the above-ground part of the sheaf from the first control group (“Natural local water”) to the fourth experimental group (“Ecoperoxide-50”). The highest dry weight of the above-the-ground part of the sheaf was marked in the fourth experimental group with spraying the plants with the solution of ecoperoxide-5 during the vegetation period (“Ecoperoxide-50”).

Moreover, on average, 7 ears were formed on one winter wheat tuft in the fourth experimental group (“Ecoperoxide-50”) with spraying plants with ecoperoxide-5 solution in the late vegetation period, which is 1-2 ears more compared to the same indicator in the remaining groups.

Higher indicators of the sheaf dry weight in all groups with spraying plants with ecoperoxide-5 solution in the late growing season, as well as the largest number of ears formed on one tuft in the fourth experimental group with spraying, were naturally confirmed at harvesting on Jul. 12, 2021, which is illustrated in Table 3.

TABLE 3
Yield and grain weight percentage in sheaves of Saratovskaya 90 winter wheat
variety with spraying with ecoperoxide-5 and without spraying in the late
vegetation period in groups with different presowing seed spraying

| | | Natural local | Complex | | |
|---|---|---|---|---|---|
| Indicators | | water | chemistry | Ecoperoxide-5 | Ecoperoxide-50 |
| Yield¹, | with | 21.0 ± 1.7 | 21.1 ± 2.1 | 28.9 ± 4.5 | 32.0 ± 2.7²** |
| hundred kg per | spraying | | | | |
| hectare | with | 16.0 ± 0.9 | 16.0 ± 0.9 | 20.3 ± 1.0³** | 26.9 ± 2.7³** |
| | spraying | | | | |
| P | | <0.05 | <0.05 | <0.1 | — |
| Weight | with | 30.7 ± 2.7 | 32.5 ± 1.5 | 31.4 ± 2.7 | 37.8 ± 3.3 |
| percentage | spraying | | | | |
| content of | without | 19.9 ± 1.4 | 19.3 ± 1.0 | 23.3 ± 0.7⁵*^{; 6}** | 29.4 ± 1.5⁴*** |
| grains in the | spraying | | | | |
| sheaf, % | | | | | |

| | | | | |
|---|---|---|---|---|
| P | <0.01 | <0.001 | <0.05 | <0.05 |

Note:
differences are reliable according to Student's t-criterion with the level of significance:
*p < 0.05,
**p < 0.01,
***p < 0.001;
¹yield was determined for 7 sheaves, each sheaf was harvested from 0.25 m²;
²differences are reliable in comparison with the groups “Natural local water” and “Complex chemistry” with spraying with ecoperoxide-5 solution according to Student's t-criterion;
^{3, 4}differences are reliable in comparison with the groups “Natural local water” and “Complex chemistry” without spraying according to Student's t-criterion;
^{5, 6}differences are reliable in comparison with the groups “Natural local water”⁵ and “Complex chemistry”⁶ without spraying according to Student's t-criterion;

As follows from Table 3, in the final result, the highest yields and weight percentage of grain in the sheaf were observed in the fourth experimental group “Ecoperoxide-50”, in which presowing spraying of seeds with Ecoperoxide-50 solution and single spraying of plants with Ecoperoxide-5 solution in the late vegetation period between the phases of tubing and milky-wax ripeness were performed.

Comparison of the yield of the fourth experimental group “Ecoperoxide-50” with spraying with the yield in the first control group (“Natural local water”), the second farmer group (“Complex chemistry”) with spraying and in the first control group (“Natural local water”), second farmer (“Complex Chemistry”) groups without spraying in the late growing season showed that in the first case the yield increase amounted to 152% (32.0×100%/21.0 (21.1)), and in the second case-200% (32.0×100%/16.0).

Comparison of the weight percentage of grain in the sheaf in the fourth experimental group “Ecoperoxide-50” with spraying with the similar indicator in the first control (“Natural local water”) and second farmer (“Complex chemistry”) groups with spraying in the late vegetation period showed that there is an increase in the weight percentage of grain in the sheaf by 123% (37.8×100%/30.7 and 116% (37.8×100%/32.5) compared to the first control group (“Natural local water”) and the second farmer (“Complex chemistry”), that there is an increase in the weight percentage content of grain in the sheaf by 123% (37.8×100%/30.7) and 116% (37.8×100%/32.5) compared to the first control (“Natural local water”) and second farmer (“Complex chemistry”) groups, respectively.

Comparison of the weight percentage of grain in the sheaf in the fourth experimental group “Ecoperoxide-50” with spraying with the similar indicator in the first control (“Natural local water”) and second farmer (“Complex chemistry”) groups without spraying in the late vegetation period showed that there is an increase in the weight percentage of grain in the sheaf by 190% (37.8×100%/19.9 and 196% (37.8×100%/19.3) compared to the first control group (“Natural local water”) and the second farmer (“Complex chemistry”), groups, respectively.

However, it is noteworthy that:
even only one presowing spraying of grain crops seeds with environmentally friendly aqueous solution of hydrogen peroxide of natural concentration without spraying of grain crops in the late vegetation period resulted in a significant reliable increase of both yield up to 127% (20.3×100%/16.0) in the third (“Ecoperoxide-5”) and up to 168% (26.9×100%/16.0) in the fourth (“Ecoperoxide-50”) experimental groups compared to the first control and second farmer groups, and in the weight percentage of grain in the sheaf from 117% (23.3×100%/19.9) to 121% (23.3×100%/19.3) in the third experimental group (“Ecoperoxide-5”) compared to the first control and second farmer groups, respectively, and from 148% (29.4×100%/19.9) to 152% (29.4×100%/19.3) in the fourth experimental group (“Ecoperoxide-50”) compared also with the first control and second farm groups, respectively;
even just a single spraying of grain crops in the late vegetation period with environmentally friendly aqueous solution of hydrogen peroxide of natural concentration without presowing spraying of grain seeds (the first control group “Natural local water” and the second farmer group “Complex chemistry”) resulted in a significant reliable increase in both yield up to 131% (21.0×100%/16.0) in the first (“Natural local water”) and up to 132% (21.1×100%/16.0) in the second (“Complex Chemistry”) groups, as well as the weight percentage of grain in the sheaf up to 154% (30.7×100%/19.9) in the first (“Natural local water”) and up to 168% (32.5×100%/19.3) in the second (“Complex chemistry”) groups compared to the first control and second farmer groups without spraying, respectively.

Comparison of the yield results obtained in the first control (“Natural local water”), second farm (“Complex chemistry”) groups without spraying and fourth experimental group (“Ecoperoxide-50”) with spraying with the official 2021 winter wheat harvest data in Saratov region as of Jun. 30, 2021 was made (Table 4).

TABLE 4
Comparison of the yield results obtained in the first control (“Natural
local water”), second farm (“Complex chemistry”) groups without
spraying and fourth experimental group (“Ecoperoxide-50”) with
spraying with the official 2021 harvest data for Saratov region as of Jun. 30, 2021.

| | Natural | Complex | | | Yield of |
|---|---|---|---|---|---|
| | local water, | chemistry | Ecoperoxide- | Yield of | “Ecopercoside- |
| Official | without | without | 50 with | “Ecopercoside- | 50” with |
| data, | spraying, | spraying, | spraying, | 50” with | spraying versus |
| hundred kg | hundred kg | hundred kg | hundred kg | spraying versus | experimental |
| per hectare | per hectare | per hectare | per hectare | official data, % | data, % |
| 16.3¹ | 16.0² | 16.0² | 32.0² | 196 | 200 |

Note:
¹average winter wheat yield in Saratov region as of Jun. 30, 2021 according to the data of the Saratov branch of the Federal State Budgetary Institution “Center of Agroanalytics” (source of information: https://specagro.ru/news/202106/v-saratovsky-oblasti-nachalas-uborochnaya-kampaniya);
²average yield of winter wheat in Saratov region as of Jul. 12, 2021 in experimental groups.

The comparison has convincingly shown that the experimental data of yield without presowing spraying of grain crop seeds with ecologically pure aqueous solution of hydrogen peroxide of natural concentration (the first control group “Natural local water”) and the second farmer group “Complex chemistry”) practically match the official data, and the percentage of yield increase in the group with the best experimental data (the fourth experimental group “Ecoperoxide-50”) in comparison with the first control group (“Natural local water”), the second farmer group (“Complex chemistry”) and official data differs only by 4%.

Therefore presowing spraying of grain crops seeds and spraying of grain crops in the late vegetation period with environmentally friendly aqueous solution of hydrogen peroxide of natural concentration is a highly effective agrotechnical method for significant increase in grain crops yield, and even only one presowing spraying of the grain crops seeds or a single spraying of the grain crops in the late vegetation period leads to a significant increase in grain crops yield, and presowing spraying of the grain crops in the late vegetation period leads to a significant increase in the grain crops yield.

1. A method of increasing the yield of grain crops, characterized in that the seeds are presowing treated by spraying them with an ecologically pure aqueous solution of hydrogen peroxide with a concentration from 2.94 μmol/l to 82.0 μmol/l or from 0.1 mg/l to 2.8 mg/l, after which the seeds are kept from 10 to 15 hours and sowing is performed.

2. The method of increasing the yield of grain crops according to claim 1, characterized by the fact that additionally the grain crops are sprayed in the late vegetation period with environmentally friendly aqueous solution of hydrogen peroxide with concentration from 2.94 μmol/l to 82.0 μmol/l or from 0.1 mg/l to 2.8 mg/l.

3. A method of increasing the yield of grain crops, characterized in that the grain crops are sprayed in the late vegetation period with an environmentally friendly aqueous solution of hydrogen peroxide with a concentration from 2.94 μmol/l to 82.0 μmol/l or from 0.1 mg/l to 2.8 mg/l.
